(19) United States
(12) Patent Application Publication
(10) Pub. No.: US 2014/0091592 A1
(43) Pub. Date: Apr. 3, 2014

(54) SUN VISOR FOR A VEHICLE

(71) Applicant: Jacky Dolisy, Blisten-en-Lorriane (FR)

(72) Inventor: Jacky Dolisy, Blisten-en-Lorriane (FR)

(73) Assignee: Johnson Controls Interiors GmbH & Co.KG, Grefrath (DE)

(21) Appl. No.: 14/007,946

(22) PCT Filed: Mar. 16, 2012
(86) PCT No.: PCT/EP2012/001184

§ 371 Date: Dec. 6, 2013

(30) Foreign Application Priority Data
Mar. 17, 2011 (DE) 102011014229.0

(51) Int. Cl. B60J 3/02

(52) U.S. Cl. CPC B60J 3/0265
USPC 296/97.9

(57) ABSTRACT

The invention relates to a sun visor for a vehicle which has a visor body and a fastening region, wherein the fastening region is for fastening the visor body to a counterpart attached to a vehicle.

### PRIOR ART

Sun visors for vehicles are generally known. They are customarily fitted to a roof lining in the vicinity of a transition region between a windshield and the roof lining in the interior of a passenger cell. In a non-use position, such sun visors extend substantially in a horizontal position parallel to the roof lining and can be folded from the roof lining in the direction of the wind shield at least partially into the field of view of a vehicle occupant, i.e. into a use position, in order to protect the vehicle occupant against solar radiation shining in from the outside. This is intended in particular to prevent the vehicle occupant from being dazzled by solar radiation and the occupant's view of the carriageway and the traffic being impaired as a result.

In principle, any vehicle fitting parts which are arranged in the vehicle interior involve the risk of a vehicle occupant being injured by such vehicle fitting parts in the event of an accident. It is therefore a continuous concern of the vehicle industry to minimize the potential risk of injury emanating from such fitting parts arranged in the vehicle interior.

A particularly high risk of injury here emanates from vehicle fitting parts which, in the event of being acted upon by a force, split in an uncontrolled manner into a plurality of parts. This is because this may create splinters which can move freely in the vehicle interior and therefore, for example, can get into the eyes of a vehicle occupant in a health-endangering manner. Furthermore, it is conceivable that an uncontrolled splitting may produce fragments having comparatively sharp broken edges, thus increasing the risk of cutting injuries for vehicle occupants.

It is therefore the object of the present invention to provide a sun visor of the type mentioned at the beginning which has a significantly reduced risk of injury for the vehicle occupants in comparison to the prior art.

### DISCLOSURE OF THE INVENTION

This object is achieved according to the invention by a sun visor for a vehicle, the sun visor having a visor body and a fastening region, wherein the fastening region is provided for fastening the visor body to a counterpart mounted on the vehicle, and wherein the sun visor has a predetermined breaking point in the fastening region.

The predetermined breaking point formed in the fastening region has the advantage that, in the event of an action of force of appropriate size on the sun visor, breaking of the predetermined breaking point is induced and an uncontrolled splitting of the sun visor at another point or at a plurality of points is prevented. In particular, the force introduced into the sun visor is absorbed by the breaking of the predetermined breaking point, thus averting further damage to the sun visor and therefore effectively preventing the occurrence of freely movable splinter particles or of sharp broken edges. The risk of injury to vehicle occupants is consequently reduced.

Provision is made, according to a preferred embodiment of the invention, for the sun visor to have a cylindrical spindle which at least partially extends through the visor body, wherein the cylindrical spindle preferably has a weakened region which acts as the predetermined breaking point. The weakened region comprises, in particular, a region of the cylindrical spindle having a reduced cross section. Alternatively, it is conceivable for the weakened region to comprise a notch in the outer surface area of the cylindrical spindle.

Provision is made, according to a further preferred embodiment of the invention, for the cylindrical spindle to have a further weakened region, in which the cylindrical spindle is of two-part design and in which the two cylindrical partial spindles of the cylindrical spindle preferably bear against each other in each case by one of the end sides thereof. The two cylindrical partial spindles bear against each other in the contact region, in particular congruently along the main direction of extent of the cylindrical spindle. On the end sides, the two cylindrical partial spindles are connected to each other preferably only in an interlocking manner and particularly preferably only in an interlocking and frictional manner. It is conceivable for the cylindrical partial spindles to be kept in contact with each other in the contact region by the material of the visor body. However, it is also conceivable for the end sides to be arranged spaced apart from each other along the main direction of extent.

Provision is made, according to a further preferred embodiment of the present invention, for the cylindrical spindle to have both the weakened region and the further weakened region, wherein the weakened region and the further weakened region are arranged adjacent to each other substantially along the main direction of extent of the cylindrical spindle.

Provision is made, according to a further preferred embodiment of the present invention, for the visor body to have a cutout along the main direction of extent of the cylindrical spindle between the weakened region and the further weakened region. The cutout makes it possible for a counter fastening means which is mounted on the vehicle and in particular is fitted to the roof lining to at least partially engage around the exposed region of the cylindrical spindle, thus enabling the sun visor to be fastened to the vehicle and in particular to the roof lining. The counter fastening means comprises, in particular, a clamping claw with or without a recess, wherein the exposed region of the cylindrical spindle is clampable into the recess.

Owing to the further weakened region, the weakened region advantageously acts as a hinge when an external force, for example in the event of an accident, acts on the cylindrical spindle in the region of the exposed region, and therefore the end sides of the cylindrical partial spindles move counter to each other perpendicularly to the main direction of extent of the cylindrical spindle and the cylindrical spindle is bent around the weakened region and in particular around the region having a reduced cross section or the notch in the outer surface area. Splitting of the visor body itself or damage to the counter fastening means is therefore avoided.

The weakened region and the further weakened region are preferably arranged adjacent to the cutout along the main direction of extent, wherein the weakened region and the further weakened region are encased, in particular, by the material of the visor body. The weakened region and the further weakened region are thereby not visible from the outside. The predetermined breaking point is therefore not visible to a vehicle occupant, and hence the external appearance of the sun visor is not impaired by the predetermined breaking point. Provision is particularly preferably made for the cylindrical spindle and/or the cylindrical partial spindles to be metal rods encased by plastic. Alternatively, it would be conceivable for the cylindrical spindle and/or the cylindrical partial spindles to be an at least partially hollow metal or plastics rod.

### BRIEF DESCRIPTION OF THE FIGURES

FIG. 1 illustrates a schematic excerpt of a sun visor according to an exemplary embodiment of the present invention.

### EXEMPLARY EMBODIMENTS OF THE INVENTION

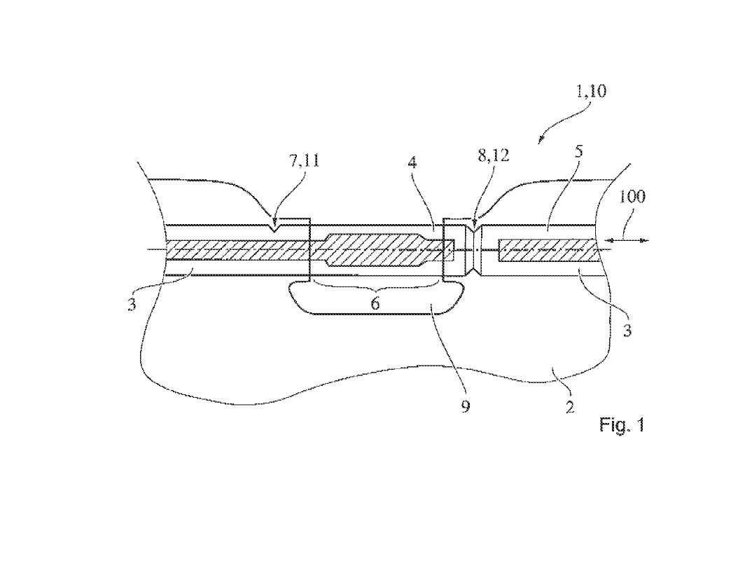

The excerpt illustrated in FIG. 1 shows a fastening region 10 of a sun visor 1 for a vehicle. The sun visor 1 comprises a visor body 2 which is provided with a cutout 9. A cylindrical spindle 3 which is encased outside the cutout 9 by the material of the visor body 2 and is exposed in the region of the cutout 9, i.e. is not encased by the material of the visor body 2, extends through the visor body 2. Said exposed region of the cylindrical spindle 3 is provided for clamping into a counter fastening means (not illustrated) which is mounted on a roof lining of the vehicle. The counter fastening means comprises, for example, a clamping claw with, or without, a recess which is open on one side and into which the exposed region 6 is clampable in a frictional and interlocking manner. The exposed region 6 is clamped in the recess, for example, by means of a leaf spring which is pretensioned in the direction of the surface area of the exposed region 6.

The sun visor 1 has, in the fastening region 10, a predetermined breaking point which, in the present example, is formed by two weakened regions of the cylindrical spindle 3, a weakened region 7 and a further weakened region 8. The weakened region 7 comprises a notch 11 in the outer surface area of the cylindrical spindle 3. The further weakened region 8 comprises a contact point 12 in which the cylindrical spindle is composed of two cylindrical partial spindles 4, 5 or is insert molded together therefrom. The two cylindrical partial spindles 4, 5 in each case bear against each other in an interlocking manner by the end sides thereof in the contact point 12, or are connected together as one cylindrical partial spindle. The two cylindrical partial spindles 4, 5 bear here against each other, in particular congruently along a main direction of extent 100 of the cylindrical spindle 3, or are insert molded as a single part. The weakened region 7 and the further weakened region 8 are arranged in such a manner that, firstly, the cutout 9 is arranged between the weakened region 7 and the further weakened region 8 and, secondly, both the weakened region 7 and the further weakened region 8 are still encased by the material of the visor body 2.

The predetermined breaking point then functions as follows: when a comparatively large external force acts on the sun visor 1, for example by means of a vehicle occupant body part moving against the sun visor 1 because of an accident, said force is transmitted to the cylindrical spindle 3, since, by the exposed region 6 of the cylindrical spindle 3 being fixed on the counter fastening means (not depicted), a corresponding yielding of the sun visor 1 is prevented. Since the two or one cylindrical partial spindles 4, 5 are connected to each other in the region of the contact point so as not to be interlocking in relation to shearing movements transversally with respect to the main direction of extent 100, or are connected to a predetermined breaking point, the cylindrical partial spindle 4 which is fixed by the counter fastening means moves in relation to the other cylindrical partial spindle 5 transversally with respect to the main direction of extent 100. This movement is assisted by the notch 11 in the weakened region 7 of the cylindrical spindle 3, and therefore the exposed region 6 buckles in relation to the remaining region of the cylindrical spindle 3. This buckling frees the exposed region 6 from the counter fastening means and causes the sun visor 1 to be detached from the roof lining. This involves a controlled breaking of the predetermined breaking point in the fastening region 10 of the sun visor 1, and therefore an uncontrolled splitting of the sun visor 1 into a plurality of individual parts having possibly dangerously sharp broken edges is prevented.

### List of Reference Numbers

1 Sun visor
2 Visor body
3 Cylindrical spindle
4, 5 Cylindrical partial spindles
6 Exposed region
7 Weakened region
8 Further weakened region
9 Cutout
10 Fastening region
11 Notch
12 Contact point
100 Main direction of extent

1.-11. (canceled)

12. A sun visor for a vehicle, comprising a visor body and a fastening region, wherein the fastening region is provided for fastening the visor body to a counterpart mounted on the vehicle, and wherein the sun visor has a predetermined breaking point in the fastening region.

13. The sun visor as claimed in claim 12, comprising a cylindrical spindle which at least partially extends through the visor body.

14. The sun visor as claimed in claim 13, wherein the cylindrical spindle comprises a weakened region.

15. The sun visor as claimed in claim 14, wherein the weakened region comprises a region of the cylindrical spindle having a reduced cross section and/or comprises a notch in the outer surface area of the cylindrical spindle.

16. The sun visor as claimed in claim 13, wherein the cylindrical spindle is of single-part design.

17. The sun visor as claimed in claim 13, wherein the cylindrical spindle is of two-part design.

18. The sun visor as claimed in claim 17, wherein two cylindrical partial spindles of the cylindrical spindle bear against each other in each case by one of the end sides thereof or are insert molded together.

19. The sun visor as claimed in claim 18, wherein end surfaces of the cylindrical partial spindles bear against each other in a contact region.

20. The sun visor of claim 19, wherein the end surfaces bear against each other congruently along the main direction of extent of the cylindrical spindle.

21. The sun visor of claim 17, wherein end surfaces of the cylindrical partial spindles are spaced apart and, on the respective end sides thereof.

22. The sun visor of claim 21, wherein end surfaces of the cylindrical partial spindles are connected to each other only in an interlocking manner.

23. The sun visor of claim 21, wherein end surfaces of the cylindrical partial spindles are connected to each other only in an interlocking and frictional manner.

24. The sun visor as claimed in claim 17, wherein the material of the visor body keeps the cylindrical partial spindles in contact with each other in a contact region.

25. The sun visor as claimed in claim 17, wherein the cylindrical partial spindles are insert molded together.

26. The sun visor as claimed in claim 13, wherein the cylindrical spindle has a first weakened region and a second weakened region, wherein the regions are arranged adjacent to each other substantially along the main direction of extent of the cylindrical spindle.

27. The sun visor as claimed in claim 26, wherein the visor body has a cutout along the main direction of extent of the cylindrical spindle between the weakened regions.

28. The sun visor as claimed in claim 26, wherein at least one of the weakened regions is at least partially encased by the visor body.

29. The sun visor as claimed in claim 26, wherein at least one of the weakened regions acts as a hinge.
